(19) United States
(12) Patent Application Publication
(10) Pub. No.: US 2025/0116235 A1
(43) Pub. Date: Apr. 10, 2025

(54) RECIRCULATION SYSTEM FOR GAS TURBINE ENGINE

(71) Applicant: Solar Turbines Inc., San Diego, CA (US)

(72) Inventors: John Stuart Bowen, San Diego, CA (US); James Underwood, Chula Vista, CA (US); Zachary Fitterer, San Diego, CA (US)

(73) Assignee: Solar Turbines Inc., San Diego, CA (US)

(21) Appl. No.: 18/480,550

(22) Filed: Oct. 4, 2023

(51) Int. Cl. F02C 3/34; F01N 3/00; F01N 13/16

(52) U.S. Cl. CPC F02C 9/16

(57) ABSTRACT

A recirculation system for a gas turbine engine includes a mixing chamber including an inlet end that receives exhaust gases containing unburnt fuel and an outlet end, and at least one recirculation conduit including an inlet opening in fluid communication with the mixing chamber proximate to the outlet end and an outlet opening in fluid communication with the mixing chamber proximate to the inlet end. The recirculation system further includes a fan. The fan is operable to receive at least one of a stream of substantially fuel-free exhaust gases present and a stream of fresh air within the at least one recirculation conduit and direct at least one of a portion of the stream of substantially fuel-free exhaust gases and a portion of the stream of fresh air into the mixing chamber to reduce an amount of unburnt fuel in the exhaust gases.

### TECHNICAL FIELD

The present disclosure relates to a recirculation system for a gas turbine engine, an exhaust system for the gas turbine engine, and a method of recirculating gases associated with the gas turbine engine.

### BACKGROUND

A gas turbine engine may operate on a variety of fuels. Each fuel may have a different energy density, due to which an amount of fuel required to operate the gas turbine engine may also vary. For example, as the energy density of the fuel reduces, the gas turbine engine may require more fuel to maintain the same load.

In some cases, the gas turbine engine may encounter a light-off condition, a late light-off condition, or a flame-out condition during operation. During such conditions, a large amount of unburnt fuel may be present in exhaust gases exiting the gas turbine engine. Depending on a fuel-to-air ratio in the exhaust gases, there may be a possibility of undesirable detonation and/or ignition in an exhaust pipe that leads the exhaust gases out of the gas turbine engine.

Therefore, a viable system is desired that may maintain the fuel-to-air ratio below a predefined value and may also maintain the heat of the exhaust gases exiting the gas turbine engine, while solving the above-described problems.

U.S. Pat. No. 8,926,917 describes systems and methods for oxidizing gases. In some embodiments, a reaction chamber is configured to receive a fuel gas and maintain the gas at a temperature within the reaction chamber that is above an autoignition temperature of the gas. The reaction chamber may also be configured to maintain a reaction temperature within the reaction chamber below a flameout temperature. In some embodiments, heat and product gases from the oxidation process can be used, for example, to drive a turbine, reciprocating engine, and injected back into the reaction chamber.

### SUMMARY OF THE DISCLOSURE

In an aspect of the present disclosure, a recirculation system for a gas turbine engine is provided. The recirculation system includes a mixing chamber including an inlet end and an outlet end. The inlet end of the mixing chamber is in fluid communication with the gas turbine engine to receive exhaust gases therefrom. The exhaust gases include unburnt fuel therein. The recirculation system also includes at least one recirculation conduit connected to the mixing chamber. The at least one recirculation conduit includes an inlet opening that is in fluid communication with the mixing chamber proximate to the outlet end of the mixing chamber. The at least one recirculation conduit further includes an outlet opening that is in fluid communication with the mixing chamber proximate to the inlet end of the mixing chamber. The recirculation system further includes a fan disposed in the at least one recirculation conduit. The fan is operable to receive, at least one of a stream of substantially fuel-free exhaust gases present proximate to the outlet end of the mixing chamber via the inlet opening of the at least one recirculation conduit, and a stream of fresh air, within the at least one recirculation conduit. The fan is also operable to direct, via the outlet opening of the at least one recirculation conduit, at least one of a portion of the stream of substantially fuel-free exhaust gases and a portion of the stream of fresh air, into the mixing chamber. Further, at least one of the portion of the stream of substantially fuel-free exhaust gases and the portion of the stream of fresh air mixes with the exhaust gases present in the mixing chamber proximate to the inlet end of the mixing chamber to reduce an amount of unburnt fuel in the exhaust gases.

In another aspect of the present disclosure, an exhaust system for a gas turbine engine is provided. The exhaust system includes an engine exhaust defining an exhaust interface. The exhaust system also includes a recirculation system in fluid communication with the exhaust interface of the engine exhaust. The recirculation system includes a mixing chamber including an inlet end and an outlet end. The inlet end of the mixing chamber is in fluid communication with the exhaust interface of the engine exhaust to receive exhaust gases therefrom. The exhaust gases include unburnt fuel therein. The recirculation system also includes at least one recirculation conduit connected to the mixing chamber. The at least one recirculation conduit includes an inlet opening that is in fluid communication with the mixing chamber proximate to the outlet end of the mixing chamber. The at least one recirculation conduit further includes an outlet opening that is in fluid communication with the mixing chamber proximate to the inlet end of the mixing chamber. The recirculation system further includes a fan disposed in the at least one recirculation conduit. The fan is operable to receive, at least one of a stream of substantially fuel-free exhaust gases present proximate to the outlet end of the mixing chamber via the inlet opening of the at least one recirculation conduit, and a stream of fresh air, within the at least one recirculation conduit. The fan is also operable to direct, via the outlet opening of the at least one recirculation conduit, at least one of a portion of the stream of substantially fuel-free exhaust gases and a portion of the stream of fresh air, into the mixing chamber. Further, at least one of the portion of the stream of substantially fuel-free exhaust gases and the portion of the stream of fresh air mixes with the exhaust gases present in the mixing chamber proximate to the inlet end of the mixing chamber to reduce an amount of unburnt fuel in the exhaust gases.

In yet another aspect of the present disclosure, a method of recirculating gases associated with a gas turbine engine is provided. The method includes providing a mixing chamber including an inlet end and an outlet end. The inlet end of the mixing chamber is in fluid communication with the gas turbine engine to receive exhaust gases therefrom. The exhaust gases include unburnt fuel therein. The method also includes providing at least one recirculation conduit. The at least one recirculation conduit is connected to the mixing chamber. The at least one recirculation conduit includes an inlet opening that is in fluid communication with the mixing chamber proximate to the outlet end of the mixing chamber. The at least one recirculation conduit further includes an outlet opening that is in fluid communication with the mixing chamber proximate to the inlet end of the mixing chamber. The method further includes operating a fan while the gas turbine engine is in operation. The fan is disposed in the at least one recirculation conduit. The method includes receiving, within the at least one recirculation conduit, at least one of a stream of substantially fuel-free exhaust gases present proximate to the outlet end of the mixing chamber via the inlet opening of the at least one recirculation conduit, and a stream of fresh air, based on the operation of the fan. The method also includes directing, based on the operation of the fan, at least one of a portion of the stream of substantially fuel-free exhaust gases and a portion of the stream of fresh air into the mixing chamber, via the outlet opening of the at least one recirculation conduit. Further, at least one of the portion of the stream of substantially fuel-free exhaust gases and the portion of the stream of fresh air mixes with the exhaust gases present in the mixing chamber proximate to the inlet end of the mixing chamber to reduce an amount of unburnt fuel in the exhaust gases.

Other features and aspects of this disclosure will be apparent from the following description and the accompanying drawings.

### BRIEF DESCRIPTION OF THE DRAWINGS

FIG. 1 is a schematic view of an exemplary gas turbine engine, according to an example of the present disclosure;

FIG. 2 is a schematic view of an exhaust system including a recirculation system for the gas turbine engine of FIG. 1, according to an example of the present disclosure;

FIG. 3 is a schematic view of a recirculation system for the gas turbine engine of FIG. 1, according to another example of the present disclosure; and

FIG. 4 is a flowchart for a method of recirculating gases associated with the gas turbine engine of FIG. 1, according to an example of the present disclosure.

### DETAILED DESCRIPTION

Wherever possible, the same reference numbers will be used throughout the drawings to refer to the same or like parts.

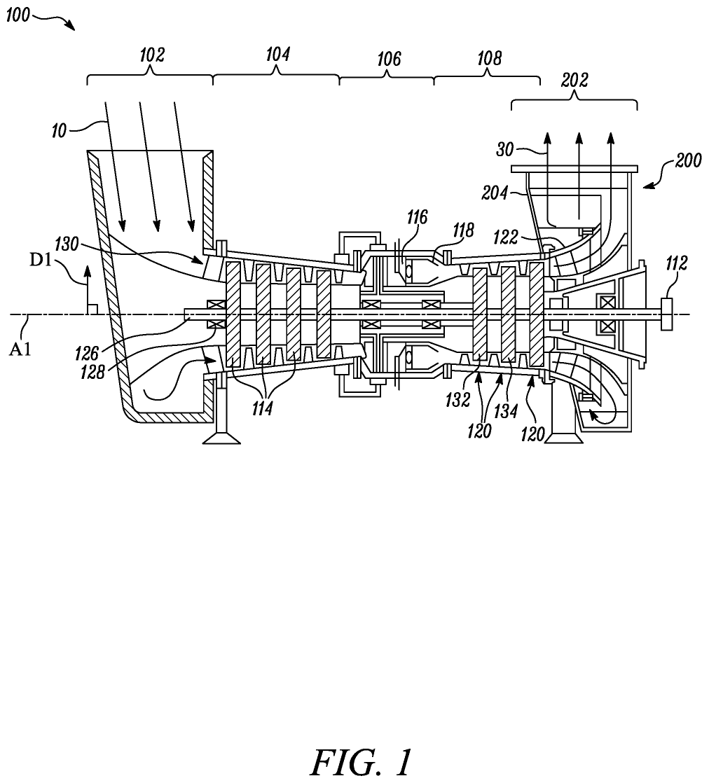

FIG. 1 is a schematic view of an exemplary gas turbine engine 100. Some of the surfaces of the gas turbine engine 100 have been left out or exaggerated for clarity and ease of explanation. Also, the disclosure may reference a forward and an aft direction. Generally, all references to “forward” and “aft” are associated with a flow direction of primary air (i.e., air used in combustion process), unless specified otherwise. For example, forward is “upstream” relative to primary air flow, and aft is “downstream” relative to primary air flow.

In addition, the disclosure may generally reference a center axis “A1” of rotation of the gas turbine engine 100. The center axis “Al” may be common to or shared with various other engine concentric components. All references to radial, axial, and circumferential directions and measures refer to the center axis “A1”, unless specified otherwise, and terms such as “inner” and “outer” generally indicate a lesser or greater radial distance from, wherein a radial direction “D1” may be in any direction perpendicular and radiating outward from the center axis “A1”.

The gas turbine engine 100 includes an inlet 102, a compressor 104, a combustor 106, a turbine 108, an exhaust system 200, and a power output coupling 112. The compressor 104 includes one or more compressor rotor assemblies 114. The combustor 106 includes one or more injectors 116 and one or more combustion chambers 118. The turbine 108 includes one or more turbine rotor assemblies 120. The exhaust system 200 includes an exhaust diffuser 122. Further, the exhaust system 200 includes an engine exhaust 202 defining an exhaust interface 204. The gas turbine engine 100 also includes a shaft 126 supported by a number of bearing assemblies 128. The shaft 126 extends along the center axis “A1”.

As illustrated in FIG. 1, the compressor rotor assemblies 114 and the turbine rotor assemblies 120 are axial flow rotor assemblies. Each turbine rotor assembly 120 includes a rotor disk (not shown) that is circumferentially populated with corresponding turbine blades (not shown). Further, each compressor rotor assembly 114 may also include a rotor disk (not shown) that is circumferentially populated with corresponding compressor blades (not shown).

A gas (typically air 10) enters the inlet 102 as a “working fluid” and is compressed by the compressor 104. In the compressor 104, the working fluid is compressed in an annular flow path 130 by the series of compressor rotor assemblies 114. In particular, the air 10 is compressed in numbered “stages”, the stages being associated with each compressor rotor assembly 114. For example, “2^{nd} stage air” may be associated with the 2^{nd} compressor rotor assembly 114. Likewise, each turbine rotor assembly 120 may be associated with a numbered stage. For example, a first stage turbine rotor assembly 132 is the forward most of the turbine rotor assemblies 120, a second stage rotor assembly 134 is located downstream of the first stage turbine rotor assembly 132, and so on. However, other numbering/naming conventions may also be used.

The compressed air 10 leaving the compressor 104 enters the combustor 106, where the compressed air 10 is diffused and fuel is added. In some examples, the fuel may include diesel, kerosene, and the like. In other examples, the fuel may include natural gas, hydrogen, refinery gas, syn gas, and the like. The air 10 and the fuel are injected into the combustion chamber 118 via the one or more injectors 116 for ignition. After the combustion reaction, energy is extracted from the combusted fuel/air mixture via the turbine 108 by each stage of the series of turbine rotor assemblies 120. Exhaust gases 30 may then be diffused in the exhaust diffuser 122. Further, the exhaust gases 30 may exit the gas turbine engine 100 via the exhaust interface 204.

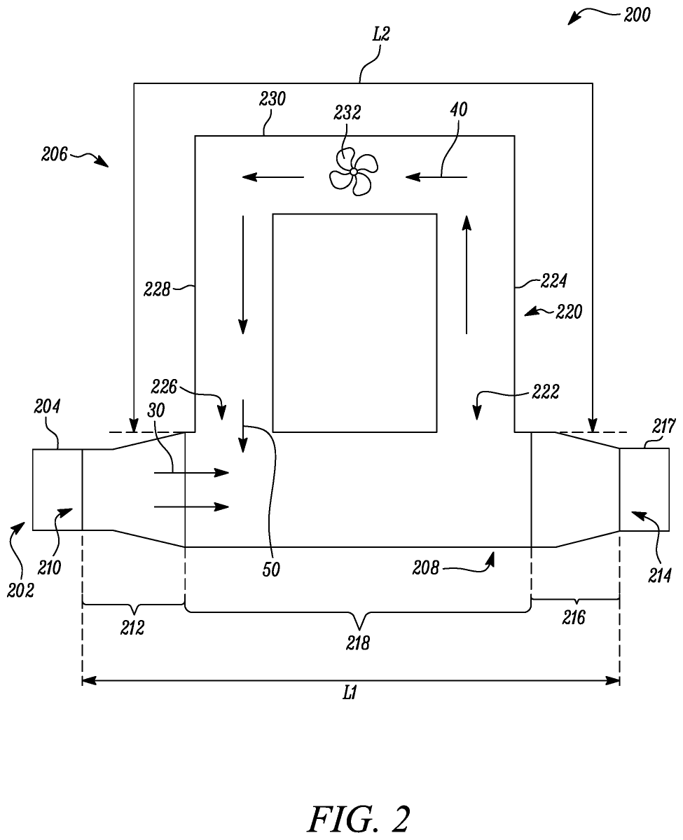

In some examples, an exhaust gas treatment system 217 (shown in FIG. 2) may be disposed in fluid communication with the engine exhaust 202 to receive the exhaust gases 30 therefrom. The exhaust gas treatment system 217 may include, for example, a waste heat recovery system, a selective catalytic reduction (SCR) module (not shown), a carbon capture system, and the like. For example, the exhaust gases 30 may be processed for e.g., to reduce harmful emissions/products present therein in the SCR module or the carbon capture system. Further, the exhaust gases 30 may be processed to recover heat from the exhaust gases 30 in the waste heat recovery system. The waste heat recovery system may recover waste heat from the exhaust gases 30 and may use the recovered waste heat for various applications, such as, in cogeneration applications where the waste heat may be used to boil water to run through a steam turbine (not shown).

FIG. 2 is a schematic view of the exhaust system 200 for the gas turbine engine 100 of FIG. 1. The exhaust system 200 includes a recirculation system 206 in fluid communication with the exhaust interface 204 of the engine exhaust 202. The recirculation system 206 may, in some examples, provide dilution of exhaust cloud discussed herein. In one example, it may be desirable to dilute the exhaust cloud to at or below a predetermined limit. In various examples, this predetermined limit may be below a lower flammability limit, a deflagration transition limit, or other limits or ranges of fuel concentration with respect to the fuel-to-air ratio. In some examples, the fuel-to-air ratio may be determined based not only on a composition of the exhaust cloud, but also a temperature of the fuel The target fuel-to-air ratio will be determined by the fuel constituents, operational characteristics of the engine, and the downstream exhaust configuration. In one example, the target dilution ratio will be such that the final concentration is below the lower flammability limit and unignitable. In another example, the target dilution ratio will be such that the concentration remains within the deflagration regime preventing a transition to fast flame. In still another example, the exhaust cloud is not diluted. This may be because the fuel-to-air ratio already meets emissions standards or a predetermined limit as discussed above.

The recirculation system 206 includes a mixing chamber 208. The mixing chamber 208 includes an inlet end 210 and an outlet end 214. The inlet end 210 of the mixing chamber 208 is in fluid communication with the gas turbine engine 100 (see FIG. 1) to receive the exhaust gases 30 therefrom. Particularly, the inlet end 210 of the mixing chamber 208 is in fluid communication with the exhaust interface 204 of the gas turbine engine 100 to receive the exhaust gases 30 therefrom. The exhaust gases 30 include unburnt fuel therein. Specifically, the exhaust gases 30 may include high amounts of unburnt fuel in case of light-off event, late light-off event, or flame-out event. Further, the outlet end 214 of the mixing chamber 208 is in fluid communication with the exhaust gas treatment system 217 associated with the gas turbine engine 100.

The mixing chamber 208 defines an inlet section 212 including the inlet end 210. The mixing chamber 208 also defines an outlet section 216 including the outlet end 214. The mixing chamber 208 further defines an intermediate section 218 extending between the inlet section 212 and the outlet section 216. The mixing chamber 208 defines a first length L1. Particularly, the inlet section 212, the outlet section 216, and the intermediate section 218 of the mixing chamber 208 together define the first length L1. The inlet section 212, the outlet section 216, and the intermediate section 218 may be integrally formed as a one-piece component. Alternatively, the inlet section 212, the outlet section 216, and the intermediate section 218 may be formed as separate components that may be coupled to each other using mechanical fasteners, welding, and the like.

The recirculation system 206 also includes one or more recirculation conduits 220 connected to the mixing chamber 208. The one or more recirculation conduits 220 defines a second length L2. The one or more recirculation conduits 220 includes an inlet opening 222 that is in fluid communication with the mixing chamber 208 proximate to the outlet end 214 of the mixing chamber 208. The one or more recirculation conduits 220 also includes an outlet opening 226 that is in fluid communication with the mixing chamber 208 proximate to the inlet end 210 of the mixing chamber 208. The intermediate section 218 of the mixing chamber 208 is in fluid communication with each of the inlet opening 222 and the outlet opening 226 of the recirculation conduit 220. In the illustrated embodiment of FIG. 2, the inlet opening 222 is in direct fluid communication with the outlet opening 226 at all times.

Further, the one or more recirculation conduits 220 includes an inlet conduit portion 224 including the inlet opening 222. Furthermore, the one or more recirculation conduits 220 includes an outlet conduit portion 228 including the outlet opening 226. The one or more recirculation conduits 220 further includes an intermediate conduit portion 230 extending between the inlet conduit portion 224 and the outlet conduit portion 228. The second length L2 is formed by each of the inlet conduit portion 224, the outlet conduit portion 228, and the intermediate conduit portion 230. Each of the first length L1 of the mixing chamber 208 and the second length L2 of the one or more recirculation conduits 220 is determined so as to promote mixing of the portion 50 of a stream of substantially fuel-free exhaust gases 40 and the exhaust gases 30 within the mixing chamber 208.

It should be noted that the term “substantially fuel-free exhaust gases” as used herein refers to exhaust gases including no or very less amount of unburnt fuel therein. In some examples, the inlet conduit portion 224, the outlet conduit portion 228, and the intermediate conduit portion 230 may be integrally manufactured as a one-piece component. Alternatively, the inlet conduit portion 224, the outlet conduit portion 228, and the intermediate conduit portion 230 may be formed as separate components that may be coupled to each other using mechanical fasteners, welding, and the like. In the illustrated embodiment of FIG. 2, the one or more recirculation conduits 220 includes a single recirculation conduit 220. However, the recirculation system 206 may include multiple recirculation conduits (for example, two recirculation conduits similar to the recirculation conduit 220) coupled to the mixing chamber 208, based on application requirements.

In the illustrated embodiment of FIG. 2, the recirculation system 206 includes a fan 232 disposed in the one or more recirculation conduits 220. However, in other embodiments, the recirculation system 206 may omit the fan 232. The fan 232 is disposed in the intermediate conduit portion 230 of the one or more recirculation conduits 220. The fan 232 is operable to receive, the stream of substantially fuel-free exhaust gases 40 present proximate to the outlet end 214 of the mixing chamber 208 via the inlet opening 222 of the one or more recirculation conduits 220, or a stream of fresh air (not shown in this embodiment), within the one or more recirculation conduits 220. In the illustrated embodiment of FIG. 2, the fan 232 is operable to receive, via the inlet opening 222 of the one or more recirculation conduits 220, the stream of substantially fuel-free exhaust gases 40 present proximate to the outlet end 214 of the mixing chamber 208 within the one or more recirculation conduits 220. In other words, when the fan 232 is operated, the fan 232 draws in the stream of substantially fuel-free exhaust gases 40 within the one or more recirculation conduits 220 via the inlet opening 222.

Further, the fan 232 is operable to direct, via the outlet opening 226 of the one or more recirculation conduits 220, a portion 50 of the stream of substantially fuel-free exhaust gases 40 or a portion of the stream of fresh air into the mixing chamber 208. In the illustrated embodiment of FIG. 2, the fan 232 is operable to direct only the portion 50 of the stream of substantially fuel-free exhaust gases 40 into the mixing chamber 208. In other words, some portion 50 of the stream of substantially fuel-free exhaust gases 40 within the one or more recirculation conduits 220 is directed towards into the mixing chamber 208 via the outlet opening 226. Further, the portion 50 of the stream of substantially fuel-free exhaust gases 40 or the portion of the stream of fresh air mixes with the exhaust gases 30 present in the mixing chamber 208 proximate to the inlet end 210 of the mixing chamber 208 to reduce an amount of unburnt fuel in the exhaust gases 30. Specifically, in the illustrated embodiment of FIG. 2, the portion 50 of the stream of substantially fuel-free exhaust gases 40 mixes with the exhaust gases 30 present in the mixing chamber 208 proximate to the inlet end 210 of the mixing chamber 208 to reduce the amount of unburnt fuel in the exhaust gases 30.

In some examples, the fan 232 is made of a high-temperature resistant material. The high-temperature resistant material of the fan 232 may allow usage of the fan 232 within the one or more recirculation conduits 220 as the exhaust gases 30 may have a very high temperature. Further, the material of the fan 232 may also exhibit moisture resistant properties and chemical resistant properties.

Although the single fan 232 is illustrated herein, the recirculation system 206 may include multiple fans disposed within the one or more recirculation conduits 220 based on factors, such as, the first length L1, the second length L2, the density of the fuel being used in the gas turbine engine 100, an amount of fuel being used, a size of the gas turbine engine 100, and the like. It should be noted that the fan 232 may be switched on when the gas turbine engine 100 starts operating so that if the gas turbine engine 100 encounters the light-off, the late light-off, or the flame-out event, the fuel-to-air ratio of the exhaust gases 30 within the mixing chamber 208 is always below a predefined value. Moreover, a speed of the fan 232 may be set so as to ensure that the fuel-to-air ratio of the exhaust gases 30 within the mixing chamber 208 is always below the predefined value.

It should be noted that the first length L1, the second length L2, and the speed of the fan 232 may be optimized based on analyzing the exhaust gases 30. In some examples, computational fluid dynamics (CFD) analysis may be performed to determine the first length L1, the second length L2, and/or the speed of the fan 232.

It should be noted that a design of the one or more recirculation conduits 220 as shown herein is exemplary in nature, and the one or more recirculation conduits 220 may include any other design suitable to allow mixing of the portion 50 of the stream of substantially fuel free exhaust gases 40 with the exhaust gases 30 proximate to the inlet section 212 of the mixing chamber 208.

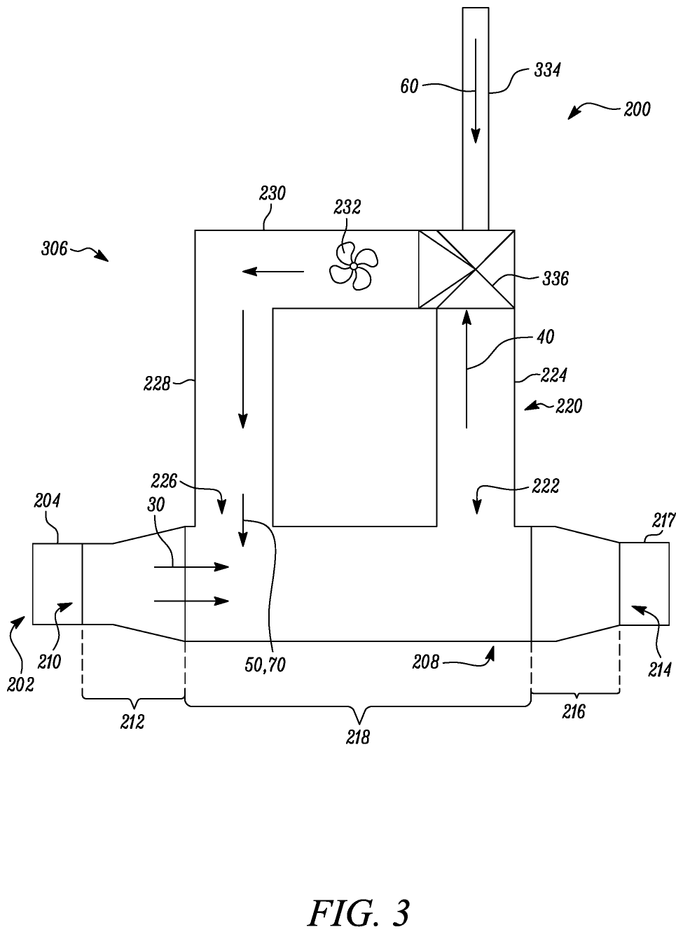

FIG. 3 illustrates a recirculation system 306, according to another embodiment of the present disclosure. The recirculation system 306 may be substantially similar to the recirculation system 206 explained in relation to FIG. 2, with common components referred to by the same numerals. The recirculation system 306 further includes a fresh air conduit 334 coupled to the one or more recirculation conduits 220. The fresh air conduit 334 receives fresh air therein and selectively directs the fresh air towards the recirculation conduit 306. The fresh air conduit 334 may be in communication with the ambient or a source of fresh air (not shown) to direct the fresh air towards the recirculation conduit 306.

The recirculation system 306 further includes a valve member 336 disposed in the one or more recirculation conduits 220. The valve member 336 may embody a 3-way valve. Further, the valve member 336 may include a solenoid operated member. The valve member 336 provides selective fluid communication of the outlet opening 226 of the one or more recirculation conduits 220 with the inlet opening 222 of the one or more recirculation conduits 220 or the fresh air conduit 334. The valve member 336 is operable in a first configuration and a second configuration.

In the first configuration, the inlet opening 222 of the one or more recirculation conduits 220 is in fluid communication with the outlet opening 226 of the of the one or more recirculation conduits 220 to direct the portion 50 of the stream of substantially fuel-free exhaust gases 40 into the mixing chamber 208. In other words, in the first configuration, the portion 50 of the stream of substantially fuel-free exhaust gases 40 is introduced into the mixing chamber 208. Thus, in the illustrated embodiment of FIG. 3, the inlet opening 222 is in fluid communication with the outlet opening 226 only when the valve member 336 is in the first configuration.

In the second configuration, the fresh air conduit 334 is in fluid communication with the outlet opening 226 of the one or more recirculation conduits 220 to direct a portion 70 of the stream of fresh air 60 into the mixing chamber 208. In other words, in the second configuration, the portion 70 of the stream of fresh air 60 is introduced into the mixing chamber 208 instead of the portion 50 of the stream of substantially fuel-free exhaust gases 40. Thus, in the illustrated embodiment of FIG. 3, the fresh air conduit 334 is in fluid communication with the outlet opening 226 only when the valve member 336 is in the second configuration. Further, the portion 70 of the stream of fresh air 60 mixes with the exhaust gases 30 present in the mixing chamber 208 proximate to the inlet end 210 of the mixing chamber 208 to reduce the amount of unburnt fuel in the exhaust gases 30.

In some examples, the stream of fresh air 60 may include ambient air. When the valve member 334 is in the second configuration, the fan 232 draws the stream of fresh air 60 into the recirculation conduit 206 and further directs, via the outlet opening 226 of the one or more recirculation conduits 220, the portion 70 of the stream of fresh air 60 into the mixing chamber 208. In other embodiments, the recirculation system 306 may omit the fan 232.

It should be noted that the valve member 336 may be switched between the first and second configurations based on control signals received from a controller (not shown). The controller may generate the control signals to switch the valve member 336 between the first and second configurations based on, for example, inputs received from an operator of the gas turbine engine 100 (see FIG. 1).

In some examples, the valve member 336 may be operated in the first configuration when the exhaust gas treatment system 217 (see FIG. 1) is in operation and the valve member 336 may be operated in the second configuration when the exhaust gas treatment system 217 is in an off state. Further, the valve member 336 may also be operated in the second configuration when the exhaust gases 30 exiting the mixing chamber 208 is to be introduced in the SCR module or if the exhaust system 200 requires purging.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure describes the recirculation system 206, 306 that may be particularly advantageous in gas turbine engines that use hydrogen or other low density fuels as the main source of fuel for operation. The fan 232 disposed in the recirculation conduit 220 draws in the stream of substantially fuel-free exhaust gases 40 or the stream of fresh air 60 into the recirculation conduit 220. Further, the fan 232 also directs the portion 50 of the stream of substantially fuel-free exhaust gases 40 or the portion 70 of the stream of fresh air 60 into the mixing chamber 208. The portion 50 of the stream of substantially fuel-free exhaust gases 40 or the portion 70 of the stream of fresh air 60 mixes with the exhaust gases 30 present in the mixing chamber 208 to reduce the amount of unburnt fuel in the exhaust gases 30. Thus, the recirculation system 206, 306 ensures that the fuel-to-air ratio in the exhaust gases 30 never exceeds the predefined value so that the exhaust gases 30 are either unignitable or the pressure rise as a result of a deflagration is accounted for.

Further, the mixing of the portion 50 of the stream of substantially fuel-free exhaust gases 40 with the exhaust gases 30 may maintain a high exhaust temperature of the exhaust gases 30, while controlling the fuel-to-air ratio below the predefined value. More particularly, the recirculation system 206 recirculates the portion 50 of the exhaust gases 30 itself rather than introducing fresh air into the exhaust gases 30, thereby maintaining the high temperature of the exhaust gases 30. Thus, the heat from the exhaust gases 30 may be recovered and used for other applications, such as, cogeneration applications.

Moreover, in an example wherein the exhaust gas treatment system 217 is in the off state, the recirculation system 306 may direct the portion 70 of the stream of fresh air 60 into the mixing chamber 208 instead of the portion 50 of the stream of substantially fuel-free exhaust gases 40 as maintaining the high temperature of the exhaust gases 30 may not be essential when the exhaust gas treatment system 217 is in the off state. In another example wherein the exhaust gases 30 are to be directed towards the SCR module, the recirculation system 306 may direct the portion 70 of the stream of fresh air 60 into the mixing chamber 208 instead of the portion 50 of the stream of substantially fuel-free exhaust gases 40 as the exhaust gases 30 may need to have a lower temperature. In yet another example wherein the exhaust system 200 needs to be purged, the recirculation system 306 may direct the portion 70 of the stream of fresh air 60 into the mixing chamber 208 instead of the portion 50 of the stream of substantially fuel-free exhaust gases 40.

Further, the outlet opening 226 is disposed far enough along the mixing chamber 208 to ensure that the stream of substantially fuel-free exhaust gases 40 entering the recirculation conduit 220 is substantially free of any unburnt fuel and is far downstream of a fuel cloud during the light-off or flame-out event. Furthermore, the first length L1 and the second length L2 may be decided so as to ensure efficient mixing of the portion 50 of the stream of substantially fuel-free exhaust gases 40 with the exhaust gases 30 at an entrance of the intermediate section 218.

Moreover, the recirculation system 206, 306 described herein may be simple in construction, may have universal applicability in gas turbine engines of different designs, and may be retrofitted in existing gas turbine engines.

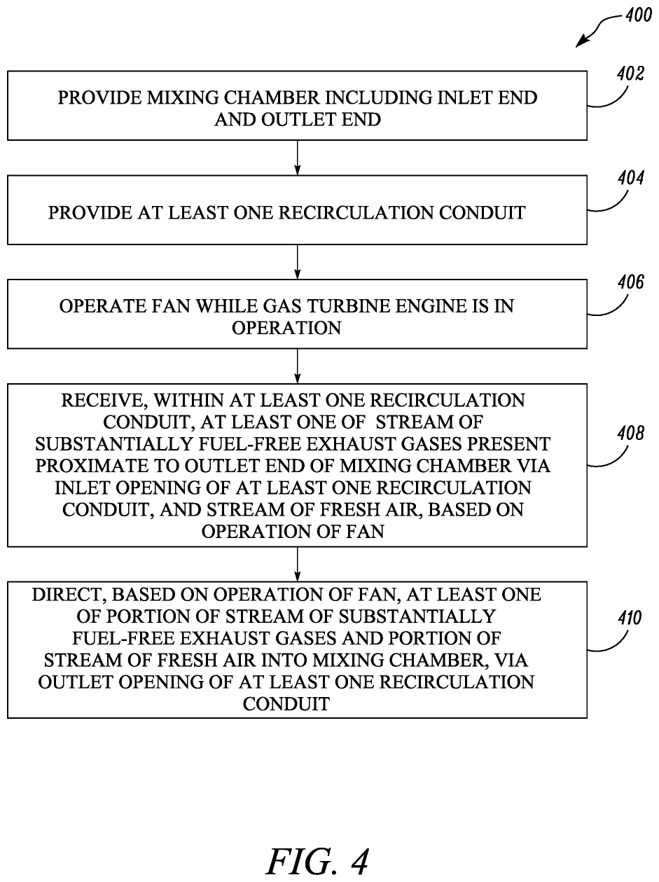

FIG. 4 illustrates a flowchart for a method 400 of recirculating gases associated with the gas turbine engine 100 of FIG. 1 is illustrated. Referring to FIGS. 1 to 4, at step 402, the mixing chamber 208 is provided. The mixing chamber 208 includes the inlet end 210 and the outlet end 214. The inlet end 210 of the mixing chamber 208 is in fluid communication with the gas turbine engine 100 to receive the exhaust gases 30 therefrom. The exhaust gases 30 include unburnt fuel therein. The step 402 also includes disposing the inlet end 210 of the mixing chamber 208 in fluid communication with the exhaust interface 204 of the gas turbine engine 100 to receive the exhaust gases 30. The step 402 further includes disposing the outlet end 214 of the mixing chamber 208 in fluid communication with the exhaust gas treatment system 217 associated with the gas turbine engine 100.

At step 404, the one or more recirculation conduits 220 is provided. The one or more recirculation conduits 220 is connected to the mixing chamber 208. The one or more recirculation conduits 220 includes the inlet opening 222 that is in fluid communication with the mixing chamber 208 proximate to the outlet end 214 of the mixing chamber 208. The one or more recirculation conduits 220 further includes the outlet opening 226 that is in fluid communication with the mixing chamber 208 proximate to the inlet end 210 of the mixing chamber 208. The one or more recirculation conduits 220 includes the inlet conduit portion 224 including the inlet opening 222, the outlet conduit portion 228 including the outlet opening 226, and the intermediate conduit portion 230 extending between the inlet conduit portion 224 and the outlet conduit portion 228.

Further, the mixing chamber 208 defines the inlet section 212 including the inlet end 210, the outlet section 216 including the outlet end 214, and the intermediate section 218 extending between the inlet section 212 and the outlet section 216. Furthermore, the intermediate section 218 is in fluid communication with each of the inlet opening 222 and the outlet opening 226 of the one or more recirculation conduits 220.

At step 406, the fan 232 is operated while the gas turbine engine 100 is in operation. The fan 232 is disposed in the one or more recirculation conduits 220.

At step 408, the one or more recirculation conduits 220 receives the stream of substantially fuel-free exhaust gases 40 present proximate to the outlet end 214 of the mixing chamber 208 via the inlet opening 222 of the one or more recirculation conduits 220, or the stream of fresh air 60, based on the operation of the fan 232.

At step 410, based on the operation of the fan 232, the portion 50 of the stream of substantially fuel-free exhaust gases 40 or the portion 70 of the stream of fresh air 60 is directed into the mixing chamber 208, via the outlet opening 226 of the one or more recirculation conduits 220. Further, the portion 50 of the stream of substantially fuel-free exhaust gases 40 or the portion 70 of the stream of fresh air 60 mixes with the exhaust gases 30 present in the mixing chamber 208 proximate to the inlet end 210 of the mixing chamber 208 to reduce the amount of unburnt fuel in the exhaust gases 30. Referring now to FIGS. 3 and 4, the recirculation system 306 further includes the fresh air conduit 334 coupled to the one or more recirculation conduits 220 and the valve member 336 disposed in the one or more recirculation conduits 220. The valve member 336 provides selective fluid communication of the outlet opening 226 of the one or more recirculation conduits 220 with the inlet opening 222 of the one or more recirculation conduits 220 or the fresh air conduit 334. The valve member 336 is operable in the first configuration and the second configuration.

In the first configuration, the inlet opening 222 of the one or more recirculation conduits 220 is in fluid communication with the outlet opening 226 of the of the one or more recirculation conduits 220 to direct the portion 50 of the stream of substantially fuel-free exhaust gases 40 into the mixing chamber 208. In the second configuration, the fresh air conduit 334 is in fluid communication with the outlet opening 226 of the one or more recirculation conduits 220 to direct the portion 70 of the stream of fresh air 60 into the mixing chamber 208.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A recirculation system for a gas turbine engine, the recirculation system comprising:
a mixing chamber including an inlet end and an outlet end, wherein the inlet end of the mixing chamber is in fluid communication with the gas turbine engine to receive exhaust gases therefrom, and wherein the exhaust gases include unburnt fuel therein;
at least one recirculation conduit connected to the mixing chamber, wherein the at least one recirculation conduit includes an inlet opening that is in fluid communication with the mixing chamber proximate to the outlet end of the mixing chamber, and wherein the at least one recirculation conduit further includes an outlet opening that is in fluid communication with the mixing chamber proximate to the inlet end of the mixing chamber; and
a fan disposed in the at least one recirculation conduit, wherein the fan is operable to:
receive, at least one of a stream of substantially fuel-free exhaust gases present proximate to the outlet end of the mixing chamber via the inlet opening of the at least one recirculation conduit, and a stream of fresh air, within the at least one recirculation conduit; and
direct, via the outlet opening of the at least one recirculation conduit, at least one of a portion of the stream of substantially fuel-free exhaust gases and a portion of the stream of fresh air, into the mixing chamber, wherein at least one of the portion of the stream of substantially fuel-free exhaust gases and the portion of the stream of fresh air mixes with the exhaust gases present in the mixing chamber proximate to the inlet end of the mixing chamber to reduce an amount of unburnt fuel in the exhaust gases.

2. The recirculation system of claim 1, wherein the fan is made of a high-temperature resistant material.

3. The recirculation system of claim 1, wherein the inlet end of the mixing chamber is in fluid communication with an exhaust interface of the gas turbine engine to receive the exhaust gases, and wherein the outlet end of the mixing chamber is in fluid communication with an exhaust gas treatment system associated with the gas turbine engine.

4. The recirculation system of claim 1, wherein the mixing chamber defines an inlet section including the inlet end, an outlet section including the outlet end, and an intermediate section extending between the inlet section and the outlet section, and wherein the intermediate section is in fluid communication with each of the inlet opening and the outlet opening of the at least one recirculation conduit.

5. The recirculation system of claim 1, wherein the at least one recirculation conduit includes an inlet conduit portion including the inlet opening, an outlet conduit portion including the outlet opening, and an intermediate conduit portion extending between the inlet conduit portion and the outlet conduit portion.

6. The recirculation system of claim 5, wherein the fan is disposed in the intermediate conduit portion.

7. The recirculation system of claim 1, wherein the mixing chamber defines a first length, wherein the at least one recirculation conduit defines a second length, and wherein each of the first length and the second length is determined so as to promote mixing of the portion of the stream of substantially fuel-free exhaust gases and the exhaust gases within the mixing chamber.

8. The recirculation system of claim 1, further comprising a fresh air conduit coupled to the at least one recirculation conduit and a valve member disposed in the at least one recirculation conduit, wherein the valve member provides selective fluid communication of the outlet opening of the at least one recirculation conduit with at least one of the inlet opening of the at least one recirculation conduit and the fresh air conduit, wherein the valve member is operable in a first configuration and a second configuration,
wherein, in the first configuration, the inlet opening of the at least one recirculation conduit is in fluid communication with the outlet opening of the of the at least one recirculation conduit to direct the portion of the stream of substantially fuel-free exhaust gases into the mixing chamber; and
wherein, in the second configuration, the fresh air conduit is in fluid communication with the outlet opening of the at least one recirculation conduit to direct the portion of the stream of fresh air into the mixing chamber.

9. An exhaust system for a gas turbine engine, the exhaust system comprising:
an engine exhaust defining an exhaust interface; and
a recirculation system in fluid communication with the exhaust interface of the engine exhaust, the recirculation system comprising:
a mixing chamber including an inlet end and an outlet end, wherein the inlet end of the mixing chamber is in fluid communication with the exhaust interface of the engine exhaust to receive exhaust gases therefrom, and wherein the exhaust gases include unburnt fuel therein;
at least one recirculation conduit connected to the mixing chamber, wherein the at least one recirculation conduit includes an inlet opening that is in fluid communication with the mixing chamber proximate to the outlet end of the mixing chamber, and wherein the at least one recirculation conduit further includes an outlet opening that is in fluid communication with the mixing chamber proximate to the inlet end of the mixing chamber; and
a fan disposed in the at least one recirculation conduit, wherein the fan is operable to:
receive, at least one of a stream of substantially fuel-free exhaust gases present proximate to the outlet end of the mixing chamber via the inlet opening of the at least one recirculation conduit, and a stream of fresh air, within the at least one recirculation conduit; and
direct, via the outlet opening of the at least one recirculation conduit, at least one of a portion of the stream of substantially fuel-free exhaust gases and a portion of the stream of fresh air, into the mixing chamber, wherein at least one of the portion of the stream of substantially fuel-free exhaust gases and the portion of the stream of fresh air mixes with the exhaust gases present in the mixing chamber proximate to the inlet end of the mixing chamber to reduce an amount of unburnt fuel in the exhaust gases.

10. The exhaust system of claim 9, wherein the fan is made of a high-temperature resistant material.

11. The exhaust system of claim 9, wherein the outlet end of the mixing chamber is in fluid communication with an exhaust gas treatment system associated with the gas turbine engine.

12. The exhaust system of claim 9, wherein the mixing chamber defines an inlet section including the inlet end, an outlet section including the outlet end, and an intermediate section extending between the inlet section and the outlet section, and wherein the intermediate section is in fluid communication with each of the inlet opening and the outlet opening of the at least one recirculation conduit.

13. The exhaust system of claim 9, wherein the at least one recirculation conduit includes an inlet conduit portion including the inlet opening, an outlet conduit portion including the outlet opening, and an intermediate conduit portion extending between the inlet conduit portion and the outlet conduit portion.

14. The exhaust system of claim 13, wherein the fan is disposed in the intermediate conduit portion.

15. The exhaust system of claim 9, wherein the mixing chamber defines a first length, wherein the at least one recirculation conduit defines a second length, and wherein each of the first length and the second length is determined so as to promote mixing of the portion of the stream of substantially fuel-free exhaust gases and the exhaust gases within the mixing chamber.

16. The exhaust system of claim 9, further comprising a fresh air conduit coupled to the at least one recirculation conduit and a valve member disposed in the at least one recirculation conduit, wherein the valve member provides selective fluid communication of the outlet opening of the at least one recirculation conduit with at least one of the inlet opening of the at least one recirculation conduit and the fresh air conduit, wherein the valve member is operable in a first configuration and a second configuration,
wherein, in the first configuration, the inlet opening of the at least one recirculation conduit is in fluid communication with the outlet opening of the of the at least one recirculation conduit to direct the portion of the stream of substantially fuel-free exhaust gases into the mixing chamber; and
wherein, in the second configuration, the fresh air conduit is in fluid communication with the outlet opening of the at least one recirculation conduit to direct the portion of the stream of fresh air into the mixing chamber.

17. A method of recirculating gases associated with a gas turbine engine, the method comprising:
providing a mixing chamber including an inlet end and an outlet end, wherein the inlet end of the mixing chamber is in fluid communication with the gas turbine engine to receive exhaust gases therefrom, and wherein the exhaust gases include unburnt fuel therein;
providing at least one recirculation conduit, wherein the at least one recirculation conduit is connected to the mixing chamber, wherein the at least one recirculation conduit includes an inlet opening that is in fluid communication with the mixing chamber proximate to the outlet end of the mixing chamber, and wherein the at least one recirculation conduit further includes an outlet opening that is in fluid communication with the mixing chamber proximate to the inlet end of the mixing chamber;
operating a fan while the gas turbine engine is in operation, wherein the fan is disposed in the at least one recirculation conduit;
receiving, within the at least one recirculation conduit, at least one of a stream of substantially fuel-free exhaust gases present proximate to the outlet end of the mixing chamber via the inlet opening of the at least one recirculation conduit, and a stream of fresh air, based on the operation of the fan; and
directing, based on the operation of the fan, at least one of a portion of the stream of substantially fuel-free exhaust gases and a portion of the stream of fresh air into the mixing chamber, via the outlet opening of the at least one recirculation conduit, wherein at least one of the portion of the stream of substantially fuel-free exhaust gases and the portion of the stream of fresh air mixes with the exhaust gases present in the mixing chamber proximate to the inlet end of the mixing chamber to reduce an amount of unburnt fuel in the exhaust gases.

18. The method of claim 17, wherein the fan is made of a high-temperature resistant material.

19. The method of claim 17, wherein the step of providing the mixing chamber further includes:
disposing the inlet end of the mixing chamber in fluid communication with an exhaust interface of the gas turbine engine to receive the exhaust gases; and
disposing the outlet end of the mixing chamber in fluid communication with an exhaust gas treatment system associated with the gas turbine engine.

20. The method of claim 17, further comprising providing a fresh air conduit coupled to the at least one recirculation conduit and a valve member disposed in the at least one recirculation conduit, wherein the valve member provides selective fluid communication of the outlet opening of the at least one recirculation conduit with at least one of the inlet opening of the at least one recirculation conduit and the fresh air conduit, wherein the valve member is operable in a first configuration and a second configuration,
wherein, in the first configuration, the inlet opening of the at least one recirculation conduit is in fluid communication with the outlet opening of the of the at least one recirculation conduit to direct the portion of the stream of substantially fuel-free exhaust gases into the mixing chamber; and
wherein, in the second configuration, the fresh air conduit is in fluid communication with the outlet opening of the at least one recirculation conduit to direct the portion of the stream of fresh air into the mixing chamber.
